(19) United States
(12) Patent Application Publication
(10) Pub. No.: US 2025/0220549 A1
(43) Pub. Date: Jul. 3, 2025

(54) SYSTEM AND METHOD FOR ASSIGNING MOBILE RELAYS IN MILLIMETER WAVE NETWORKS

(71) Applicant: INDIAN INSTITUTE OF TECHNOLOGY BOMBAY, Mumbai (IN)

(72) Inventors: Gaurav Sudhir KASBEKAR, Mumbai (IN); Mandar Ravindra NALAVADE, Mumbai (IN)

(73) Assignee: INDIAN INSTITUTE OF TECHNOLOGY BOMBAY, Mumbai (IN)

(21) Appl. No.: 18/773,141

(22) Filed: Jul. 15, 2024

(30) Foreign Application Priority Data
Dec. 28, 2023 (IN) 202321089373

(51) Int. Cl. H04W 40/12; H04W 88/04

(52) U.S. Cl. CPC H04W 40/12; H04W 88/04

(57) ABSTRACT

Embodiments herein disclose a system and a method for assigning one or more mobile relays to each source-destination pair and one or more intermediate stops in each time slot, thereby achieving high data rates between the sources and their corresponding destinations. Embodiments herein disclose a system and a method for calculating channel gains from each source to its corresponding destination, wherein a reference signal at fixed power is received from each source.

### TECHNICAL FIELD

Embodiments disclosed herein relate to millimeter wave networks, and more particularly to managing the assignment of mobile relays in millimeter wave networks.

### BACKGROUND

Millimeter wave (mmWave) communication plays a significant role in the context of Fifth Generation (5G) and beyond 5G wireless networks. mmWave communications enable high data rates, low latency, and increased capacity, as promised by 5G and beyond 5G networks.

However, blockage and propagation losses are major concerns in mmWave communication. Relays are used to overcome such problems and they can significantly improve the performance of mm Wave communication systems. Many algorithms such as the heuristic relay selection algorithm, deep learning based relay selection algorithm, etc., have been designed to select a good relay to improve network performance. However, the assignment of mobile relays to source-destination pairs in mm Wave communication networks is a complex task that requires careful consideration of various factors to ensure optimal performance.

Hence, there is a need in the art for solutions which will overcome the above mentioned drawback(s), among others.

### OBJECTS

The principal object of embodiments herein is to disclose a system and a method for assigning one or more mobile relays to one or more source-destination pairs and one or more intermediate stops in each time slot in millimeter wave networks, thereby achieving high data rates between the sources and their corresponding destinations.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a millimeter wave network with a source, a destination, one or more mobile relays, and a controller, according to embodiments as disclosed herein;

FIG. 2 depicts an example system, wherein the system comprises one or more source-destination pairs, one or more mobile relays at initial location So, a controller, and one or more intermediate stops, and the plurality of source-destination pairs and the plurality of mobile relays operate at mm Wave frequencies, according to embodiments as disclosed herein; and

FIGS. 3A and 3B are flowcharts depicting the method of assigning one or more mobile relays to one or more source-destination pairs and one or more intermediate stops, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

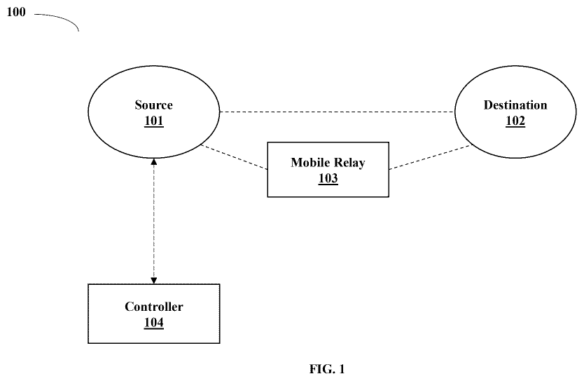

The embodiments herein achieve methods and systems for assigning one or more mobile relays to one or more source-destination pairs and one or more intermediate stops in each time slot in millimeter wave networks. Referring now to the drawings, and more particularly to FIGS. 1 through 3B, where similar reference characters denote corresponding features consistently throughout the figures, there are shown embodiments.

Embodiments herein disclose a system and a method for assigning one or more mobile relays to one or more source-destination pairs and one or more intermediate stops in each time slot, thereby achieving high data rates between the sources and their corresponding destinations.

FIG. 1 depicts a millimeter wave network with a source, a destination, one or more mobile relays, and a controller. The millimeter wave network 100, as depicted, comprises a source 101, a destination 102, one or more mobile relays 103, and a controller 104. The source 101, the destination 102 and the one or more mobile relays 103 and the controller 104 can use millimeter wave (mmWave) frequencies for communication among themselves.

Embodiments herein are explained using an example of a network 100 comprising a mobile relay 103; however, it may be obvious to a person of ordinary skill in the art that the network 100 may comprise one or more mobile relays 103.

The controller 104 can communicate with the source-destination pair 101,102 and the one or more mobile relays 103 using mmWave frequencies. The controller 104 can consider each time slot to be divided into the following: channel measurement, relay assignment, and data transmission.

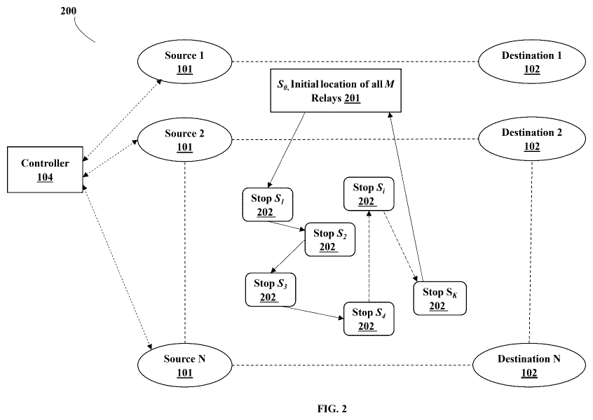

FIG. 2 depicts an example system, wherein the system comprises one or more source-destination pairs, one or more mobile relays, a controller, and one or more intermediate stops, and the plurality of source-destination pairs and the plurality of mobile relays operate at mmWave frequencies. The system 200, as depicted comprises one or more source-destination pairs 101,102, one or more mobile relays 103 at initial location So 201, a controller 104, and one or more intermediate stops 202.

The system 200 comprises N source-destination pairs, where N is an integer and N≥1. In an embodiment herein, the source and destination of a j^{th} source-destination pair is denoted as source j and destination j respectively. The controller 104 can communicate with the source-destination pairs 101,102 and the one or more mobile relays 103 using mmWave frequencies. In an embodiment herein, the controller 104 can divide the time into slots of equal durations. In each time slot, each source j is an element of {1, . . . , N} (i.e., j∈{1, . . . , N}) and has data that is to be sent to destination j. In an embodiment herein, there can be M mobile relays 103, wherein M is an integer and M≥1. In an embodiment herein, each relay can be mounted on a vehicle, e.g., an unmanned aerial vehicle (UAV), an autonomous terrestrial vehicle, a two wheeled vehicle, a three wheeled vehicle, a four wheeled vehicle, or any other vehicle that can accommodate the relay. The system 200 comprises of K intermediate stops, Sᵢ, wherein i can be an element of {1, . . . , K} (i.e., i∈{1, . . . , K}) where K is a positive integer and K is greater than or equal to the number of mobile relays, M, (i.e., K≥M).

At the beginning of each time slot, all M relays 103 are located at a fixed initial location, S₀ 201, wherein the fixed route travelled by the relays 103 is shown by arrows. The controller 104 can consider each time slot to be divided into the following: channel measurement, relay assignment, and data transmission.

In the channel measurement part of the time slot, the mobile relay 1 103 can start from the initial location S₀ 201 and can traverse a fixed route with K intermediate stops 202 (as S₁, S₂, . . . , S_{K}) and can then return to the initial location S₀ 201. K is greater than or equal to the number of mobile relays, M, (i.e., K≥M) and is a positive integer. The fixed route is in the region between the sources 101 and destinations 102. At each intermediate stop, Sᵢ (wherein i can be an element of {1, . . . , K} (i.e., i∈{1, . . . , K})), the mobile relay 1 can transmit a reference signal at a fixed power, and each of the N sources 101 and each of the N destinations 102 can determine the received power level. In an embodiment herein, the controller 104 can use this procedure to determine the channel gains from each source 101 and each destination 102 to each stop, Sᵢ 201. In an embodiment herein, the controller 104 can determine the channel gains from each source 101 to its corresponding destination 102, when each source j can be an element of {1, . . . , N} (i.e., j∈{1, . . . , N}) by transmitting of a reference signal at a fixed power by the source j and the corresponding destination j measuring the received power level.

Embodiments herein can assign relays to each source-destination pair 101,102. This can involve assigning a subset of the M relays 103 to a subset of the K intermediate stops 202 (at most one relay per one stop) and communicating this assignment to each source-destination pair 101,102.

During data transmission, a subset of the sources 101 can directly communicate with their corresponding destinations 102, whereas the other sources 101 will communicate with their corresponding destinations 102 via the assigned relay 103 when transmitting data in a time slot. Let Cᵢ be the energy cost incurred by a mobile relay 103 to travel from the initial location, S₀ 201, to stop Sᵢ 202 and back to the initial location S₀ 201.

In the system 200, as depicted let Tⱼ⁰ be the data rate at which the source j can send data to destination j in the data transmission portion of the current time slot if no relay has been assigned to source-destination pair j. Also, let Tⱼⁱ be the data rate at which the source j can send data to destination j in the data transmission portion of the current time slot, where i can be an element of {1, . . . , K} (i.e., i∈{1, . . . , K}), if a relay located at stop Sᵢ is assigned to source-destination pair j. In an embodiment herein, the data rate can be calculated using the Shannon channel capacity of the channel from source j to destination j. The data rate can be calculated using a table that maps different channel gain values to corresponding modulation and coding schemes which are being used for data communication in the system 200. Then the controller 104 can calculate the data rate Tⱼ⁰ (where j is an element of {1, . . . , N} (i.e., j∈{1, . . . , N})), using the channel gains between different sources 101 and their corresponding destinations 102 (which can be measured in the channel measurement portion of the current time slot), and the channel capacities of the direct communication channels from different sources 101 to their corresponding destinations 102. Also, the controller 104 can calculate the data rates Tⱼⁱ (where i can be an element of {1, . . . , K} (i.e., i∈{1, . . . , K}), j can be an element of {1, . . . , N} (i.e., j∈{1, . . . , N})) using the channel gains between different sources 101 and relay stops 202 and between different relay stops 202 and destinations 102 (which can be measured in the channel measurement portion of the current time slot), using the cooperative relaying scheme (for example, decode-and-forward, amplify-and-forward, selection relaying and so on) used (if any), and the channel capacities of the communication channels from different sources 101 to their corresponding destinations 102 via mobile relays 103 at different intermediate stops 202.

In an embodiment herein, the controller 104 can compute Tⱼⁱ, Tⱼ⁰ and Cᵢ for different values of i and j (wherein i∈{1, . . . , K} and j∈{1, . . . , N}), using which the controller 104 can compute values of i and j for which an objective function, Tⱼⁱ-Tⱼ⁰-wCᵢ is maximized, with ties being broken at random, where w can be a positive constant.

At the beginning of the relay assignment part of a time slot, the controller 104 can consider i₁ and j₁ to be the values for which the objective function, Tⱼⁱ-Tⱼ⁰-wCᵢ, is maximized. If Tⱼ_{₁}ⁱ^{₁}-Tⱼ_{₁}⁰-wCᵢ_{₁}>0, the mobile relay 1 travels to Sᵢ_{₁} and can serve as a relay between the source j₁ 101 and destination j₁ 102. Otherwise, no relay is assigned to any source-destination pair, and the relay assignment procedure is stopped. Further, in an embodiment herein, the controller 104 can calculate the values of i (which can be an element of {1, . . . , K} minus {i₁}, (i.e., i∈{1, . . . , K}\{i₁})) and j (which can be an element of {1, . . . , N} minus {j₁}, (i.e., j∈{1, . . . , N}\{j₁})) for which Tⱼⁱ-Tⱼ⁰-wCᵢ is maximized, with ties being broken at random.

Let i₂ and j₂ be the values for which Tⱼⁱ-Tⱼ⁰-wCᵢ is maximized. If Tⱼ_{₂}ⁱ^{₂}-Tⱼ_{₂}⁰-wCᵢ_{₂}>0, then the mobile relay 2 travels to stop Sᵢ_{₂} and serves as a relay between the source j₂ 101 and destination j₂ 102. Otherwise, no relay is assigned to any source-destination pair in this step and the relay assignment procedure is stopped.

Next, the controller 104 can repeat the procedure (as described in the two preceding paragraphs) until it is stopped at some step due to the maximum Tⱼⁱ-Tⱼ⁰-wCᵢ being less than or equal to 0, all M relays have been assigned to source-destination pairs, or each source-destination pair has been assigned at least one relay.

Further, in the data transmission portion of the current time slot, each source communicates with its corresponding destination using the relay assigned to it, if any, or directly if no relay has been assigned to it. At the end of the time slot, all the mobile relays that were assigned to some source-destination pairs travel back to the initial location S₀ 201.

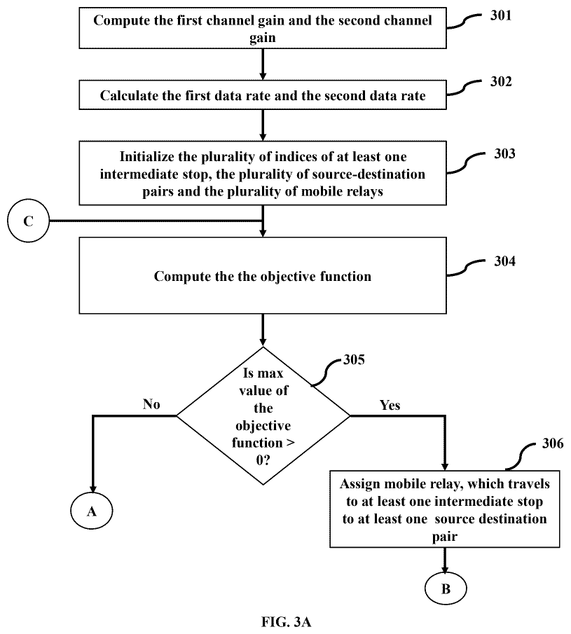

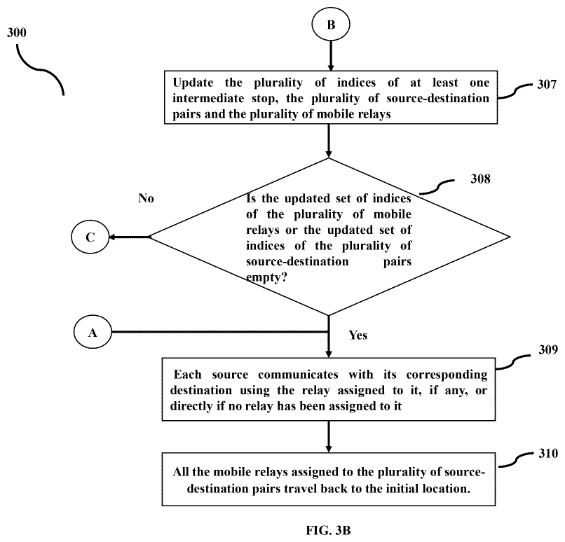

FIG. 3A and 3B are flowcharts depicting a method for assigning one or more

mobile relays to one or more source-destination pairs and one or more intermediate stops. Consider that in method 300 the first mobile relay, travels from initial stop S₀ to each intermediate stop Sᵢ, for every stop i∈{1, . . . , K}. In step 301, the controller 104 computes the first channel gain from each source 101 and each destination 102 to each intermediate stop 202 and the second channel gain from each source to its corresponding destination. In step 302, the controller 104 calculates the data rates at which each source can send data to its corresponding destination without any relay (i.e., directly) and with a relay at each intermediate stop (i.e., the first data rate and the second data rate respectively). In step 303, the controller 104 initializes the plurality of indices of at least one intermediate stop, the plurality of source-destination pairs and the plurality of mobile relays. Then in step 304, the controller 104 computes the values of the objective function for the index of at least one intermediate stop from the plurality of intermediate stops and the index of at least one source destination pair from the plurality of source destination pairs. In step 305, the controller 104 checks whether the maximum value of the objective function is positive (i.e., greater than 0). If the maximum value of the objective function is not positive, in step 309, each source communicates with its corresponding destination using the relay assigned to it, if any, or directly if no relay has been assigned to it. If the maximum value of the objective function is positive, in step 306, the controller 104 assigns a mobile relay, which travels to at least one intermediate stop to at least one source destination pair. In step 307, the controller 104 updates the plurality of indices of at least one intermediate stop, the plurality of source-destination pairs and the plurality of mobile relays. In step 308, the controller 104 checks whether the set of updated indices of the plurality of mobile relays or the set of updated indices of the plurality of source-destination pairs are empty or not. If the set of updated indices of the plurality of mobile relays and set of updated indices of the plurality of source-destination pairs are not empty, the controller 104 repeats the process from step 304 onwards until the set of updated indices of the plurality of mobile relays or the set of updated indices of the plurality of source-destination pairs becomes empty. If the set of updated indices of the plurality of mobile relays or the set of updated indices of the plurality of source-destination pairs is empty, in step 309, each source communicates with its corresponding destination using the relay assigned to it, if any, or directly if no relay has been assigned to it. In step 310, all mobile relays assigned to the plurality of source-destination pairs travel back to the initial location. The various actions in method 300 may be performed in the order presented, in a different order or simultaneously. Further, in some embodiments, some actions listed in FIGS. 3A and 3B may be omitted.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

Embodiments disclosed herein describe a system and a method for assigning one or more mobile relays to one or more source-destination pairs and one or more intermediate stops in each time slot, thereby achieving high data rates between the sources and their corresponding destinations. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

We claim:

1. A method for assigning at least one relay in a millimeter wave (mmWave) network, the method comprising:
computing (301), by the controller (104), a first set of channel gains from at least one source (101) to at least one destination (102) via at least one intermediate stop (202), and a second channel gain from at least one source (101) directly to at least one destination (102);
calculating (302), by the controller (104), a first data rate at which at least one source (101) sends data to at least one destination (102) directly and a second data rate at which at least one source (101) sends data to at least one destination (102) with at least one relay;
initializing (303), by the controller 104, a plurality of indices of at least one intermediate stop (202), a plurality of source-destination pairs (101,102) and a plurality of mobile relays (103);
computing (305), by the controller (104), the values of an objective function for the index of at least one intermediate stop from the plurality of intermediate stops and the index of at least one source destination pair from the plurality of source destination pairs;
enabling (306), by the controller (104), the at least one source (101) to communicate with the at least one destination directly, if the computed objective function is not positive; and
assigning (307), by the controller (104), at least one mobile relay from the plurality of mobile relays to a source-destination pair, if the computed objective function is positive, wherein the at least one mobile relay travels to at least one intermediate stop (202) to enable the at least one source-destination pair (101,102) to communicate with each other.

2. The method, as claimed in claim 1, the method further comprises assigning, by the controller (104), at least one mobile relay to at least one source-destination pair (101,102), till all of the plurality of mobile relays or the plurality of source-destination pairs is empty.

3. The method, as claimed in claim 1, the method further comprises communicating (310), by the at least one source (101) with the at least one destination via the assigned mobile relay.

4. A controller in a millimeter wave (mmWave) network, the controller configured to:
compute a first set of channel gains from at least one source (101) to at least one destination (102) via at least one intermediate stop (202), and a second channel gain from at least one source (101) directly to at least one destination (102);
calculate a first data rate at which at least one source (101) sends data to at least one destination (102) directly and a second data rate at which at least one source (101) sends data to at least one destination (102) with at least one relay;
initialize a plurality of indices of at least one intermediate stop (202), a plurality of source-destination pairs (101,102) and a plurality of mobile relays (103);
compute the values of an objective function for the index of at least one intermediate stop from the plurality of intermediate stops and the index of at least one source destination pair from the plurality of source destination pairs;
enable the at least one source (101) to communicate with the at least one destination directly, if the computed objective function is not positive; and
assign at least one mobile relay from the plurality of mobile relays, if the computed objective function is positive, wherein the at least one mobile relay travels to at least one intermediate stop (202) to enable the at least one source-destination pair (101,102) to communicate with each other.

5. The controller, as claimed in claim 4, the controller is further configured to assign at least mobile relay to at least one source-destination pair (101,102), till all of the plurality of mobile relays or the plurality of source-destination pairs is empty.
